(19) United States
(12) Patent Application Publication
(10) Pub. No.: US 2008/0207363 A1
(43) Pub. Date: Aug. 28, 2008

(54) Low cost torque vectoring system

(75) Inventor: Joel M. Maguire, Northville, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/678,068

(22) Filed: Feb. 23, 2007

(51) Int. Cl. F16H 9/12; F16G 1/00; F16H 63/06

(52) U.S. Cl. 474/8; 474/17; 474/237; 474/25; 474/272

(57) ABSTRACT

A torque vectoring drive system is presented for use in a motor vehicle. The torque vectoring drive system includes a differential unit having an input shaft, a first axle shaft, a second axle shaft, and a carrier, the differential rotatably driving the axle shafts while permitting the axle shafts to have independent speeds of rotation. The system includes a continuously variable transmission (CVT) having an input shaft driveably coupled to the carrier of the differential and an output shaft driveably coupled to the first axle shaft of the differential. The CVT is operable to variably control the drive torque of the first axle shaft relative to the second axle shaft to provide torque vectoring.

### TECHNICAL FIELD

This application relates to differentials, drive axles and drive train assemblies for transmitting motive power to the driven wheels of motor vehicles and, more particularly, to drive axles equipped with a torque vectoring drive system for selectively allocating or vectoring available drive torque between the driven wheels of a motor vehicle.

### BACKGROUND OF THE INVENTION

It is known to apply torque vectoring drive systems on motor vehicles, such as motor vehicles utilizing applications using AWD (all wheel drive) technology. AWD drive provides well recognized advantages to motor vehicle traction and handling in foul-weather conditions (both on and off-road).

Torque vectoring is the practice of enabling the motor vehicle driveline to selectively and dynamically increase the rotational speed of one driven axle relative to an opposing second driven axle to enhance vehicle handling and cornering. The effect is similar to the effect of stability control systems, well known in the automotive industry, which selectively slows or brakes an individual wheel to affect vehicle handling. In navigating a motor vehicle around a corner, vehicles equipped with torque vectoring technology are equipped to apply a disproportionate amount of drive shaft torque to the outside driven wheel, thereby creating an inward yaw that pushes the motor vehicle more resolutely into the corner improving the ability of the vehicle to navigate a tight corner. Torque vectoring systems can also stabilize over steer situations, such as when the engine throttle is abruptly closed during vehicle cornering. Torque vectoring between the driven wheels on opposing sides of the vehicle can significantly improve vehicle handling in cornering.

A significant limitation of currently available torque vectoring systems is the cost of the mechanical components making up the torque vectoring system. Prior art torque vectoring solutions are characterized by systems having a high mechanical content. In many instances existing torque vectoring systems are in effect adding two additional transmissions to each motor vehicles thereby driving up vehicle production cost proportionally. The relatively high prices of currently available torque vectoring systems limits the application of torque vectoring technology to premium motor vehicles where the cost of such systems can be covered in the sticker price. There remains a need for a low cost torque vectoring system permitting torque vectoring technology to be included on lower cost motor vehicles.

### SUMMARY OF THE INVENTION

The present invention provides a torque vectoring drive system for use in a two wheel drive or an AWD (all wheel drive) motor vehicle. The torque vectoring drive system includes a widely used motor vehicle drive differential technology for transmitting torque and rotary motion from an input drive shaft to a first output shaft and a second output shaft. As is known by those skilled in the art, the differential transmits torque and rotary motion from the input drive shaft to the first and second differential output shafts while permitting the first and second output shafts to rotate at different speeds. The torque vectoring drive system according to the present invention further includes a continuously variable transmission (CVT). The CVT includes a CVT input shaft driveably coupled to the bevel gear of the differential. The CVT input shaft rotates at the speed of the differential bevel gear, bypassing the differential gear assembly of the differential, thereby having a rotary speed that is a fixed ratio of the rotary speed of the differential input drive shaft. The CVT has an output shaft that is driveably coupled to the first output shaft of the differential. The CVT includes a means of variably driveably coupling the CVT input shaft to the CVT output shaft. The variable coupling means setting the ratio of the rotational speed of the CVT input shaft to the CVT output shaft. A control system is provided for selectively and dynamically adjusting the rotation speed ratio of the CVT input shaft to the CVT output shaft. The CVT output shaft directly or indirectly rotatably and torsionally drives a first driven wheel of the motor vehicle. The second driven wheel of the motor vehicle is torsionally and rotatably driven by the second output shaft of the differential. The torque vectoring drive axle control system is operable to dynamically adjust the ratio of the torque delivered to the first driven wheel (first drive torque) to the torque delivered to the second driven wheel (second drive torque) by adjusting the rotation speed ratio of the CVT input shaft to the CVT output shaft, thereby adjusting the side to side drive torque/traction characteristic of the motor vehicle.

According to one aspect of the invention, the continuously variable transmission (CVT) is a belt driven system having a plurality of pulleys having adjustable walls or sheave portions to provide a variable and adjustable effective pulley drive radius. The CVT includes a variable width drive pulley driveably coupled to the CVT input shaft. The variable width drive pulley has two spaced confronting beveled walls for confining and frictionally engaging a drive belt there between. The spacing between the beveled walls is variable to adjustably effect the belt drive radius of the drive pulley. The CVT further includes a variable width driven pulley. The driven pulley has two spaced confronting beveled walls for confining and frictionally engaging the drive belt therebetween. As with the drive pulley, the spacing between the beveled walls of the driven pulley is variable to adjust the effective belt drive radius of the driven pulley. The CVT includes a drive belt sized and adapted to frictionally engage and variably rotationally couple the drive pulley to the driven pulley. The driven pulley is rotatably and driveably connected, either directly or indirectly, to the CVT output shaft. The control system, as discussed above, selectively and dynamically adjusts the spacing between the beveled walls of each variable width pulley to adjust the rotational speed ratio. The beveled walls of the pulleys are adjusted together to maintain a fixed belt drive path circumference between the drive and driven pulleys.

According to another aspect of the invention, the driven pulley is driveably coupled to the CVT output shaft by a first transfer pulley which is driveably connected to the driven pulley of the CVT, a second transfer pulley is driveably connected to the CVT output shaft by a second drive belt drive that is sized and adapted to be frictionally engaged with and transfer rotary motion between the first transfer pulley and the second transfer pulley.

According to another aspect of the invention, at least one of the drive belts of the CVT is a metallic drive belt.

According to another aspect of the invention, the first transfer pulley is replaced with a first transfer sprocket, the second transfer pulley is replaced with a second transfer sprocket, and the second drive belt is replaced with a drive chain engaging the sprockets to torsionally and rotatably couple the first transfer sprocket to the second transfer sprocket.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 illustrates a fragmentary schematic view of a torque vectoring drive system consistent with the present invention.

### DESCRIPTION OF THE PREFERRED EMBODIMENTS

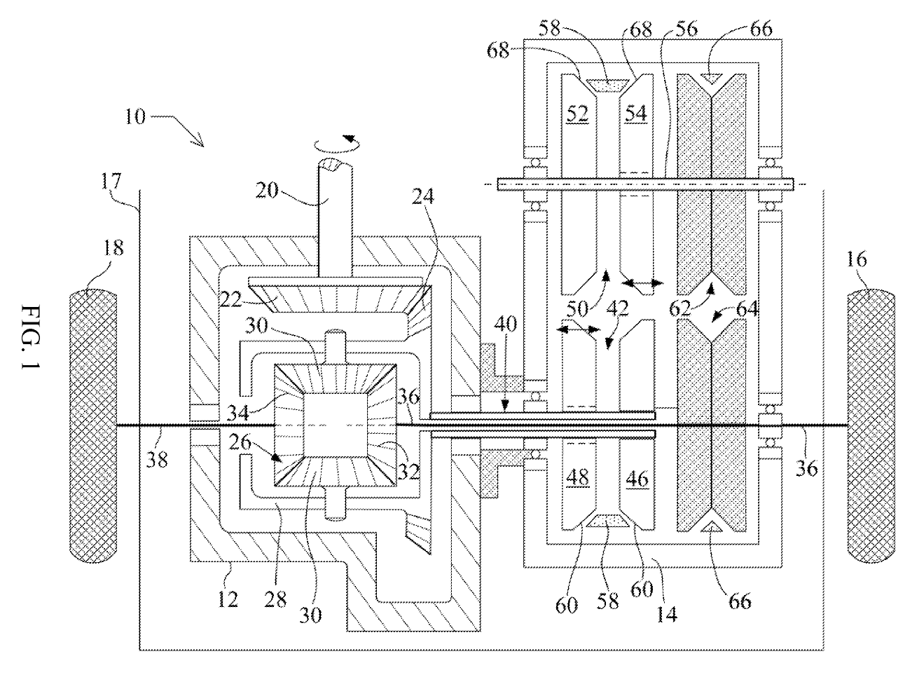

Referring to FIG. 1, the torque vectoring drive system 10 has as its main components a conventional motor vehicle differential unit 12 driveably coupled to a continuously variable transmission (CVT) 14. The combination of the differential unit 12 and the continuously variable transmission 14 provides an active over drive or under drive to the first driven wheel 16 of a motor vehicle 17.

Power is supplied to the pinion gear 22 by the drive shaft 20 powered by the motor vehicle engine (not shown), transmission (not shown) and other drive train components. The pinion gear 22 meshably engages the bevel gear 24 via meshing of the gear teeth of the pinion gear 22 and bevel gear 24. The carrier 28 is secured to or is part of the bevel gear 24 so that the carrier 28 rotates as a unit with the bevel gear 24. A plurality of planetary gears forming a differential gear assembly 26 is positioned within the carrier 28. Two opposing planetary gears 30 of the differential gear assembly 26 are rotatably secured to the carrier 28. Planetary side gears 32 and 34 meshably engage the opposing planetary gears 30, with planetary side gear 32 driveably coupled to one portion of the first output shaft 36 and planetary side gear 34 driveably coupled to the second output shaft 38. Another portion of the output shaft 36 rotatably and torsionally drives the first driven wheel 16, while output shaft 38 rotatably and torsionally drives the second driven wheel 18. In FIG. 1, the output shafts also correspond to axle shafts for wheels 16 and 18, although in general the output shafts and the axle shafts may be separate entities.

The carrier 28, being secured to or a part of the bevel gear 24, rotates in the same direction as the bevel gear 24, but within that motion, the planetary side gears 34 and 32 can counter-rotate relative to each other. It is to be understood that the invention is not limited to the exemplary differential unit illustrated and described, but may instead utilize any other type and configuration of differential drive units as would be known to those skilled in the art.

In discussion presented in this paragraph the presence of CVT 14 is ignored. It is a characteristic of a standard differential (without the presence of CVT 14 illustrated in FIG. 1) that both output shafts 36 and 38 would receive the same torque. Depending of driving conditions, however, one output shaft may be rotating at a different speed than the other output; for example, if one wheel is on ice and the other is on dry pavement, or when the motor vehicle is navigating a turn. Regardless of the difference in rotational speed between the output shafts 36 and 38 in the standard differential system (again, in this paragraph the presence of CVT 14 is ignored), both output shafts receive the same torque. Combining the CVT 14 with the differential 12 in FIG. 1 permits the torque delivered to the output shafts (which also serve as axle shafts in the illustrated embodiment) to be selectively adjusted or vectored as described in detail below.

In general, torque vectoring systems are applied to improve the torque/traction characteristics of the motor vehicle by adjusting the side to side drive torque/traction characteristics of the motor vehicle. The torque vectoring drive system 10 as disclosed herein is a component of an active torque vectoring system for a motor vehicle. The torque vectoring drive system 10 provides a comparatively low cost torque vectoring solution permitting torque vectoring technology to be applied to lower cost motor vehicles where the use of more costly torque vectoring systems of the present art would not be a viable economic option.

The exemplary continuously variable transmission (CVT) 14 illustrated in FIG. 1 is one embodiment of a CVT suitable for adding torque vectoring system technology to a motor vehicle without requiring major modifications to the drive train components. The invention is not limited to the use of the exemplary CVT 14 as illustrated in FIG. 1, but may instead be practiced using any of the known CVT technologies as would be known to those skilled in the art. The exemplary continuously variable transmission (CVT) 14 comprises a CVT input shaft 40 driveably and rotatably connecting the bevel gear 24 of differential 12 to a variable width drive pulley 42 in CVT 14. The drive pulley 42 is provided with confronting beveled walls 60 consisting of a fixed wall 46 and an adjustable or variable wall 48 for confining and frictionally engaging a drive belt 58 therebetween. The variable wall 48 is adjustable axially on the CVT input shaft 40 to vary the spacing between the beveled portions of walls 46, 48 so as to adjust the effective belt drive radius of the drive pulley 42. As used herein, the belt radius is the distance between the rotational axis of the pulley and the location where the belt frictionally engages the beveled portions of walls 46, 48 of the pulley. Reducing the spacing between confronting beveled walls 46, 48 results in the fixed width drive belt 58 moving outwards on the beveled walls 46, 48 of drive pulley 42 to a greater radial distance from the CVT input shaft 40, thereby increasing the effective radius of the drive pulley 42. Similarly, increasing the spacing between the confronting beveled walls 46, 48 results in the fixed width drive belt 58 moving inwards on the beveled walls 46, 48 of pulley 42 to a smaller radial distance from the CVT input shaft 40, thereby decreasing the effective radius of the drive pulley 42.

In a similar fashion, the driven pulley 50 is provided with confronting beveled walls 68 consisting of a fixed wall 52 and an adjustable or variable wall 54 for confining and frictionally engaging a fixed width drive belt 58 therebetween. The fixed width drive belt 58 driveably and rotatably connects the drive pulley 42 to the driven pulley 50. The variable wall 54 of the driven pulley 50 is adjustable axially on the intermediate shaft 56 to vary the spacing between the beveled walls 52 and 54 so as to adjust the effective belt drive radius of the driven pulley 50 in a similar fashion to the previous discussion of the drive pulley 42. As the drive belt 58 has a fixed circumferential length, variable width pulleys 42 and 50 are adjusted simultaneously so as to maintain constant the circumferential length of the belt path over pulleys 42 and 50 to maintain drivable engagement of drive belt 58 with the drive pulley 42 and driven pulley 50.

The driven pulley 50 is driveably and rotatably coupled to the first transfer pulley 62 by the shaft 56 so as to transfer rotary motion and torque from driven pulley 50 to the first transfer pulley 62. The first transfer pulley 62 is driveably and rotatably connected to the second transfer pulley 64 by a second drive belt 66. The second transfer pulley 64 is driveably coupled or secured to the first output shaft or shaft portion 36. The first output shaft or shaft portion 36 is driveably coupled to the planetary side gear 32 of the differential 12 as well as driveably coupled to the first driven wheel 16. Transfer pulleys 62 and 64 are fixed width pulleys each sharing a similar belt radius and serving to transfer rotary motion and torque from intermediate shaft 56 to the first output shaft or shaft portion 36. In another aspect of the invention (not shown) the transfer pulleys 62 and 64 along with the second drive belt 66 may be replaced with a first transfer sprocket and a second transfer sprocket rotatably coupled by a drive chain.

Adjustment of the variable width pulleys 42 and 50 control the ratio of the rotational speeds between the CVT input shaft 40 and the first output shaft 36. The first output shaft 36 in FIG. 1 is also (in the illustrated embodiment) the CVT output shaft, although in general the first output shaft and the CVT output shaft may be separate shafts that are drivably coupled or alternately may be portions of the same shaft. As defined herein, the CVT has a CVT transmission ratio equal to the rotary speed of the CVT output shaft divided by the rotary speed of the CVT input shaft. When the effective belt radius of the drive pulley 42 matches the effective belt radius of the driven pulley 50, then (given that in the illustrated embodiment the transfer pulleys 62 and 64 share the same belt radius) the CVT input shaft 40 and the first output shaft 36 rotate at the same speed, resulting in a CVT transmission ratio of one. Adjusting variable pulley 42 to have a larger effective belt radius than driven pulley 50 results in the rotation speed ratio of the CVT input shaft 40 to the rotational speed of the first output shaft 36 to be less than one (CVT input shaft 40 rotating slower than first output shaft 36 and CVT transmission ratio greater than one). In the embodiment illustrated in FIG. 1, if for a simplifying illustrative example we assume the first transfer pulley 62 and the second transfer pulley 64 share the same radius, then the CVT transmission ratio is determined directly from the effective belt radius of the driven pulley 50 (R_{ef2}) divided by the effective belt radius of the drive pulley 42 (R_{ef1}). In this example, the torque transmitted through the CVT from the CVT input shaft 40 to the first output shaft 36 is reduced in direct inverse proportion to the CVT transmission ratio.

As defined herein, the ratio of the torque delivered to the first output shaft 36 (T₁) relative to the torque delivered to the second output shaft 38 (T₂) is the torque vector ratio (TVR). When the torque vector ratio (TVR) is less than one, then the first output shaft 36 receives less torque than the second output shaft 38 (i.e., torque is vectored to the second output shaft). Similarly, when the torque vector ratio is greater than one, then the first output shaft 36 receives more torque than the second output shaft 38 (i.e., torque is vectored to the first output shaft).

TVR=T₁/T₂ (1)

Where:
TVR=torque vector ratio
T₁=first output shaft torque
T₂=second output shaft torque

Therefore, by selectively and dynamically adjusting the CVT transmission ratio, the distribution of drive torque from the differential 12 can be intentionally and selectively vectored between the first driven wheel 16 and the second driven wheel 18, providing the vehicle with the advantages of torque vectoring as discussed earlier. The disclosed torque vectoring system can be integrated with motor vehicle traction and stability control systems to permit target driven wheels to be commanded to speed up or slow down without just applying vehicle brakes.

While the best modes for carrying out the invention have been described in detail, those familiar with the art to which this invention relates will recognize various alternative designs and embodiments for practicing the invention within the scope of the appended claims.

1. A torque vectoring system for use in a motor vehicle, comprising:
a differential unit comprising:
a differential input shaft;
a first differential output shaft having a first drive torque; and
a second differential output shaft having a second drive torque, the differential unit rotatably driving the output shafts while permitting the output shafts to have independent speeds of rotation; and
a continuously variable transmission (CVT) comprising:
a CVT input shaft rotatable at a first rotary speed, the CVT input shaft driven by the differential input shaft; and
a CVT output shaft portion rotatable at a second rotary speed, the CVT output shaft portion driveably coupled to the first differential output shaft, the CVT having a CVT transmission ratio equal to the second rotary speed divided by the first rotary speed,
the CVT operable in combination with the differential unit to dynamically adjust a ratio of the first drive torque to the second drive torque by selectively controllably adjusting the CVT transmission ratio.

2. The torque vectoring system of claim 1, wherein the continuously variable transmission further comprises:
an adjustable width drive pulley having a controllably variable first effective drive belt radius, the drive pulley driveably coupled to the CVT input shaft, the drive pulley having two spaced confronting beveled walls for confining and frictionally engaging a portion of a drive belt there between, the spacing between the beveled walls controllably adjusting the first effective belt drive radius;
an adjustable width driven pulley having a controllably variable second effective drive belt radius, the driven pulley having two spaced confronting beveled walls for confining and frictionally engaging a second portion of the drive belt there between; the spacing between the beveled walls of the driven pulley controllably adjusting the second effective drive belt radius, the driven pulley driveably connected to the CVT output shaft portion; and
the drive belt sized and adapted to frictionally engage and variably rotationally couple the drive pulley to the driven pulley,
wherein the first effective drive belt radius and the second effective drive belt radius are controllably adjusted simultaneously to maintain a constant circumferential belt path length for the drive belt, wherein a controlled ratio of the first and second effective drive belt radii determines the CVT transmission ratio.

3. The torque vectoring system of claim 2, wherein the drive belt comprises a metallic drive belt.

4. The torque vectoring system of claim 1, wherein said first differential output shaft and said CVT output shaft are portions of the same shaft.

5. The torque vectoring system of claim 1, wherein said first differential output shaft and said CVT output shaft are separate shafts that are drivably coupled.

6. A torque vectoring system for use in a motor vehicle having a first driven wheel and a second driven wheel, comprising:
a differential unit comprising:
a differential input shaft driveably coupled to a pinion gear;
a bevel gear driveably meshed to the pinion gear;
a plurality of meshed planetary gears forming a differential gear assembly;
a first differential output shaft; and
a second differential output shaft driveably coupled to the differential gear assembly, the differential gear assembly transmitting torque to the output shafts while permitting the output shafts to have independent speeds of rotation;
a continuously variable transmission (CVT) comprising:
a CVT input shaft having a first rotary speed, the CVT input shaft driveably coupled to the bevel gear; and
a CVT output shaft having a second rotary speed, the CVT output shaft driveably coupled to the first output shaft of the differential unit, the CVT having a selectively controllable CVT transmission ratio equal to the second rotary speed divided by the first rotary speed;
a first axle shaft driveably connected to the CVT output shaft, the first axle shaft rotatably and torsionally driving the first driven wheel, the first axle shaft having a first drive torque; and
a second axle shaft rotatably and torsionally driving the second driven wheel, the second axle shaft having a second drive torque, the second axle shaft driveably connected to the second output shaft of the differential unit, the CVT operable in combination with the differential unit to dynamically adjust a ratio of the first drive torque to the second drive torque by selectively controllably adjusting the CVT transmission ratio.

7. The torque vectoring system of claim 6, wherein the continuously variable transmission further comprises:
an adjustable width drive pulley having a controllably variable first effective drive belt radius, the drive pulley driveably coupled to the CVT input shaft, the drive pulley having two spaced confronting beveled walls for confining and frictionally engaging a portion of the drive belt there between, the spacing between the beveled walls controllably adjusting the first effective belt drive radius;
an adjustable width driven pulley having a controllably variable second effective drive belt radius, the driven pulley having two spaced confronting beveled walls for confining and frictionally engaging a second portion of the drive belt there between; the spacing between the beveled walls of the driven pulley controllably adjusting the second effective drive belt drive radius, the driven pulley driveably connected to the CVT output shaft; and
the drive belt sized and adapted to be frictionally engaged with and to variably rotationally couple the drive pulley to the driven pulley,
wherein the first effective drive belt radius and the second effective drive belt radius are controllably adjusted simultaneously to maintain a constant circumferential belt path length for the drive belt, wherein a controlled ratio of the first and second effective drive belt radiuses determines the CVT transmission ratio.

8. The torque vectoring system of claim 7, wherein the driven pulley is driveably coupled to the CVT output shaft by:
a first transfer pulley driveably connected to the driven pulley;
a second transfer pulley driveably connected to the CVT output shaft; and
a second drive belt sized and adapted to be frictionally engaged with and transfer rotary motion and torque between the first transfer pulley and the second transfer pulley.

9. The torque vectoring system of claim 8, wherein the drive belts comprise metallic drive belts.

10. The torque vectoring system of claim 6, wherein said first differential output shaft and said CVT output shaft are portions of the same shaft.

11. The torque vectoring system of claim 6, wherein said first differential output shaft and said CVT output shaft are separate shafts that are drivably coupled.

12. A vehicle comprising:
an input driveshaft;
a differential;
a continuously variable transmission (CVT); and
at least a pair of output vehicle wheels;
wherein said driveshaft is drivably connected to said differential;
wherein said differential is drivably connected to one of said wheels; and
wherein said CVT includes a pair of adjustable width pulleys, one of said pulleys being drivably connected to said differential and the other of said pulleys being drivably connectable to the other of said wheels, whereby to permit said wheels to rotate at different speeds in response to said one of said pulleys being adjusted.
